(19) United States
(12) Patent Application Publication
(10) Pub. No.: US 2009/0304866 A1
(43) Pub. Date: Dec. 10, 2009

(54) PROTEIN-ENRICHED FROZEN DESSERT

(75) Inventors: Lionel Jean René Bovetto, Larringes (FR); Christophe Joseph Etienne Schmitt, Servion (FR); Dinakar Panyam, Fremont, CA (US)

Correspondence Address: WINSTON & STRAWN LLP;PATENT DEPARTMENT, 1700 K STREET, N.W., WASHINGTON, DC, 20006, US

(73) Assignee: Nestec S.A.

(21) Appl. No.: 12/294,574

(22) PCT Filed: Mar. 21, 2007
(86) PCT No.: PCT/EP2007/002495

§ 371 Date: Jun. 15, 2009

(30) Foreign Application Priority Data
Mar. 27, 2006 (EP) 06006298.1

(51) Int. Cl. A23G 9/38; A23G 9/32

(52) U.S. Cl. 426/61; 426/565; 426/656; 426/72; 426/74; 426/71

(57) ABSTRACT

The present invention relates to nutritionally balanced frozen desserts, in particular to pasteurized frozen desserts having a high protein content and to a method for manufacturing them. Whey protein micelles, concentrates thereof or powders thereof can be used in the manufacture of such frozen desserts.

### FIELD OF THE INVENTION

The present invention relates to frozen desserts, in particular to pasteurised frozen dessert having a high protein content and to a method for manufacturing them. The present invention also relates to the use of whey protein micelles, concentrates thereof and/or powders thereof in the manufacture of frozen desserts.

### BACKGROUND

There have been many attempts to improve the nutritional quality of frozen sorbets, especially of fat-containing ice-cream.

In order to provide consumers with healthy frozen confections, many different solutions have to date been suggested. These include providing reduced fat frozen confectionery, reducing the amount of carbohydrates present in traditional frozen confections, reducing the presence of additives etc.

For instance U.S. Pat. No. 5,308,628 relates to a method for preparing yoghurt based frozen dairy products which are thickener-free.

Low-fat ice-creams have been on the market for decades. These recipes generally have a higher carbohydrate content, make use of artificial sweeteners or have a higher protein content. High-protein frozen food products are disclosed in US 2006/0008557 for instance. Similarly, non-fat or reduced fat frozen desserts comprising proteinaceous macrocolloids are described in U.S. Pat. No. 4,855,156.

U.S. Pat. No. 4,853,246 describes dairy products which can be frozen and which have a reduced lactose and fat content.

WO 01/64065 further provides frozen confectionery compositions which are ideally suited for diets as they are hypocaloric and comprise a high amount of proteins.

Often however, these solutions do not yield nutritionally balanced frozen confectionery, as one of protein, carbohydrate or fat is not present in adequate amounts or is present in excessive amounts. Indeed, the present solutions often compensate the lack of one nutrient (e.g. fat) with an excess of another (e.g. carbohydrates).

In an attempt to provide a confection having an improved nutritional balance, EP 1 676 486 teaches the use of carbohydrates in a range of 55-75% of the total energy content, protein in the range of 10-15% of the total energy content, and fat in the range of 15-40% of the total energy content and wherein less than 15% of the total energy content is provided by saturated fatty acids. However, the amount of protein present is still quite low and the amount of carbohydrate quite high.

The protein content of ice cream can be enhanced by selecting a variety of commercially available protein-rich dairy ingredients. However, this solution has its limits and increasing the amount of proteins used in frozen confectionery is often associated with a number of problems during thermal processing of ice cream mixes. For example, high protein content can induce viscosity increase, destabilisation and gelation which lead to undesirable texture and decreased stability of the final frozen confectionery product.

Increasingly indeed proteins, in particular whey proteins, are being used as a partial substitute for fat and also as an emulsifier in food applications.

U.S. Pat. No. 6,767,575 B1 discloses a preparation of an aggregate whey protein product, whereby whey protein is denatured by acidification and heating. The protein aggregates thus obtained are used in food application.

GB 1079604 describes improvements in the manufacture of cheese, whereby whey proteins undergo heat treatment at an optimum pH value, in order to obtain insoluble whey proteins which are then added to raw milk.

WO 93/07761 is concerned with the provision of a dry microparticulated protein product which can be used as a fat substitute.

U.S. Pat. No. 5,750,183 discloses a process for producing proteinaceous microparticles which are useful as fat substitute containing no fat.

EP 0412590 also uses denatured whey protein as fat replacer in food compositions such as ice cream.

A proteinaceous fat substitute is also disclosed in WO 91/17665 whereby the proteins are in the form of a water-dispersible microparticulated denatured whey protein.

U.S. Pat. No. 4,107,334 further suggests that heat denaturation of whey protein is not sufficient to provide ice cream with desirable properties and further suggests modifying the denatured protein by proteolysis prior to incorporation into ice cream.

One of the problems encountered with the production of products containing globular proteins in general, and whey protein in particular, however is their limited processability. Indeed, protein molecules when heated, or when subjected to acidic or alkaline environment or in the presence of salts tend to lose their native structure and reassemble in various random structures such as gels, for example.

The preparation of gelled aqueous compositions of whey proteins is the subject of EP 1281322.

Elofsson et al. in International Dairy Journal, 1997, p. 601-608 describe cold gelling of whey protein concentrates.

Similarly, Kilara et al. in Journal of Agriculture and Food Chemistry, 1998, p. 1830-1835 describes the effect of pH on the aggregation of whey proteins and their gelation.

This gel effect presents limitation in terms of not only processability (e.g. clogging of machines used in the manufacture of protein-containing products) but also in terms of the texture thus obtained, which may not be desirable for the frozen dessert applications.

Controlled denaturation of proteins is thus desirable in order to widen the use of proteins.

In the Proceedings of the Second International Whey Conference, Chicago, October 1997, reported in International Dairy Federation, 1998, 189-196, Britten M. discusses heat treatments to improve functional properties of whey proteins. A process for producing whey protein microparticle dispersion at 95° C. is described.

Erdman in Journal of American College of Nutrition, 1990, p. 398-409 describes that the quality of microparticulated protein is not affected despite using high shear and heat.

EP 0603981 also describes a heat stable oil-in-water emulsion containing proteins.

Sato et al. in U.S. Pat. No. 5,882,705 obtained micellar whey protein by heat treating a hydrolysed whey protein solution. The micellar whey protein are characterised by an irregular shape.

A further problem encountered by the use of whey proteins is their impact on the taste profile of the end-product e.g. they may leave an astringent sensation.

Thus, an object of the invention is to provide a technique for improving the impact of frozen desserts on a consumer, such as e.g. the nutritional profile of frozen desserts and/or improving the sensory profile of protein-containing frozen desserts.

### SUMMARY OF THE INVENTION

Accordingly, this object is achieved by means of the features of the independent claims. The dependent claims develop further the central idea of the present invention.

To achieve this object, a pasteurised frozen dessert having more than 6%, preferably more than 8%, most preferred more than 10% protein content and an essentially neutral pH value, the fat caloric value being less than 45% is provided according to a first aspect of the invention.

In a further aspect, the invention provides for a pasteurised frozen ice cream having per weight at least 8% proteins, 15% to 28% carbohydrates and 3% to 7% fat.

### FIGURES

The present invention is further described hereinafter with reference to some preferred embodiments shown in the accompanying figures in which:

FIG. 1 shows a highly schematic structure of a whey protein micelle.

FIG. 2 shows a SEM (Scanning electron microscopy) micrograph of a whey protein micelle powder obtained after spray drying of a 20% protein content dispersion after microfiltration.

FIG. 3 is a negative staining TEM micrograph of a whey protein micelles dispersion obtained at 4% protein content.

FIG. 4 is a negative staining TEM micrograph of a whey protein micelle dispersion obtained at 20% protein content after microfiltration.

FIG. 5 is a negative staining TEM micrograph from a 4% whey protein micelles dispersion based on a pure whey protein micelle spray dried powder after dispersion at 50° C. in deionised water.

FIG. 6 is a SEM micrograph showing the internal structure after cutting of a spray-dried powder granule that is presented on FIG. 2.

FIG. 7 is a negative staining TEM micrograph of a 4% whey protein micelles dispersion based on a pure freeze dried whey protein micelle powder after at room temperature in deionised water. Scale bar is 0.5 micrometre.

FIG. 8 is a photograph of a whey protein micelle concentrate at 20% obtained after evaporation in which 4% NaCl is added.

FIG. 9 is a bright field light microscopy micrograph of whey protein micelle powder semi-thin section after toluidine blue staining. Scale bar is 50 microns.

FIG. 10 is a SEM micrograph of the hollow whey protein micelle powder particle after cutting. Left: internal structure. Right: Detail of the whey protein micelle composing the powder particle matrix. Scale bars are 10 and 1 micron respectively.

### DETAILED DESCRIPTION OF THE INVENTION

The present invention, in one aspect, relates to frozen desserts comprising whey protein micelles.

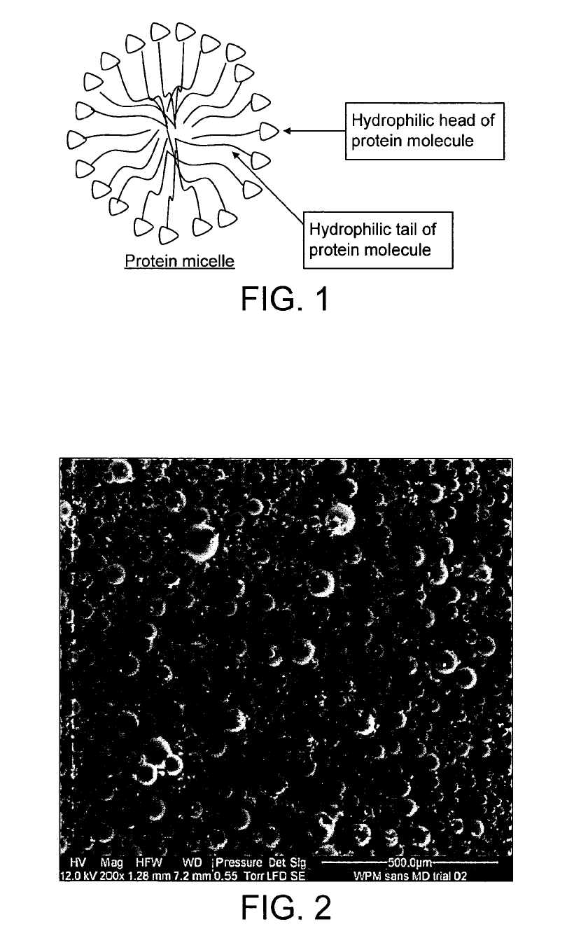

FIG. 1 is a schematic representation of the whey protein micelles which can be used in the frozen dessert of the present invention, wherein the whey proteins are arranged in such a way that the hydrophilic parts of the proteins are oriented towards the outer part of the agglomerate and the hydrophobic parts of the proteins are oriented towards the inner “core” of the micelle. This energetically favourable configuration offers good stability to these structures in a hydrophilic environment.

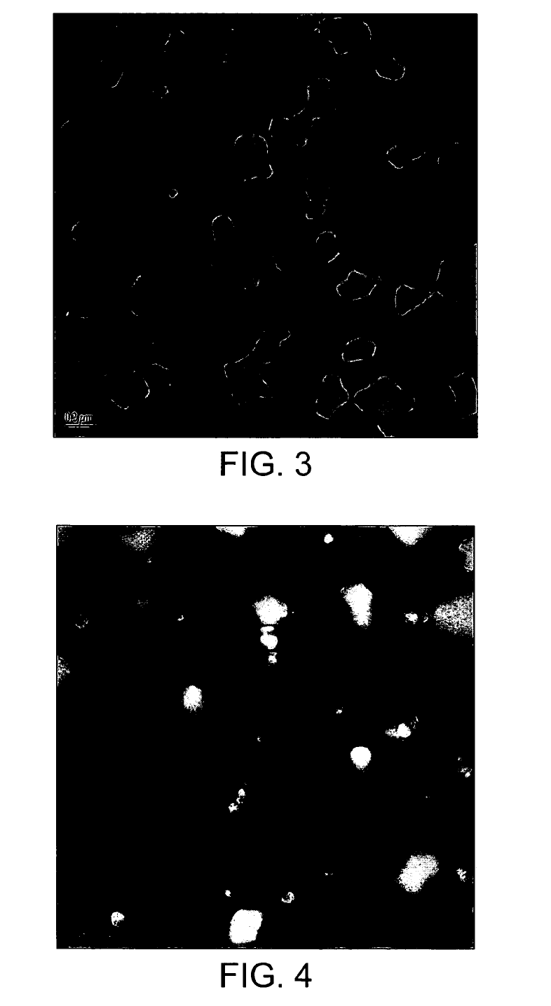

The specific micelle structure can be seen from the figures, in particular FIGS. 3, 4, 5 and 6, wherein the micelles used in the present invention consist essentially of spherical agglomerates of denatured whey protein. The micelles of the present invention are particularly characterised by their regular, spherical shape.

Due to their dual character (hydrophilic and hydrophobic), this denatured state of the protein seems to allow interaction with a hydrophobic phase, e.g. a fat droplet or air, and a hydrophilic phase. The whey protein micelles therefore have perfect emulsifying and foaming properties.

Furthermore, the micelles may be produced in such a way that they have a sharp size distribution, such that more than 80% of the micelles produced have a size smaller than 1 micron, preferably between 100 nm and 900 nm, more preferably between 100-770 nm, most preferably between 200 and 400 nm.

The mean diameter of the micelles can be determined using Transmission Electron Microscopy (TEM).

Without wishing to be bound by theory, it is thought that during micelle formation, the micelle reach a “maximum” size, due to the overall electrostatic charge of the micelle repelling any additional protein molecule, such that the micelle cannot grow in size any longer. This may account for the narrow size distribution observed.

The whey protein micelles which can be used in the present invention are obtainable e.g. by a process described in detail in the following.

As the whey protein to be used in manufacture of micelles, any commercially available whey protein isolates or concentrates may be used, i.e. whey protein obtained by any process for the preparation of whey protein known in the art, as well as whey protein fractions prepared therefrom or proteins such as β-lactoglobulin (BLG), α-lactalbumin and serum albumin. In particular, sweet whey obtained as a by-product in cheese manufacture, acid whey obtained as by-product in acid casein manufacture, native whey obtained by milk microfiltration or rennet whey obtained as by-product in rennet casein manufacture may be used as the whey protein. The whey protein may be from a single source or from mixtures of any sources. It is preferable that the whey protein does not undergo any hydrolysis step prior to micelle formation. Thus, the whey protein is not subjected to any enzymatic treatment prior to micellisation. According to the invention, it is important that the whey protein be used in the micelle formation process and not hydrolysates thereof.

The native whey protein source is not restricted to whey isolates from bovine origin, but pertains to whey isolates from all mammalian animal species, such as from sheep, goats, horses, and camels. Also, the process described herein may apply to mineralised, demineralised or slightly mineralised whey preparations. By “slightly mineralized” is meant any whey preparation after elimination of free minerals which are dialyzable or diafiltrable, but which maintains minerals associated to it by natural mineralisation after preparation of the whey protein concentrate or isolate, for example. These “slightly mineralised” whey preparations have had no specific mineral enrichment.

Whey proteins have a better protein efficiency ratio (PER=118) compared for example to casein (PER=100). PER is a measure of a protein quality assessed by determining how well such protein supports weight gain.

It can be calculated by the following formula:

PER=body weight growth (g)/protein weight intake (g).

| Examples: | PER | % Casein |
|---|---|---|
| casein | 3.2 | 100 |
| Egg | 3.8 | 118 |
| Whey | 3.8 | 118 |
| Whole Soya | 2.5 | 78 |
| Wheat gluten | 0.3 | 9 |

For producing whey protein micelles, whey proteins may be present in an aqueous solution in an amount of 0.1 wt. % to 12 wt. %, preferably in an amount of 0.1 wt. % to 8 wt. %, more preferably in an amount of 0.2 wt. % to 7 wt. %, even more preferably in an amount of 0.5 wt. % to 6 wt. %, most preferably in an amount of 1 wt. % to 4 wt. % on the basis of the total weight of the solution.

The aqueous solution of the whey protein preparation as present before the micellisation step may also comprise additional compounds, such as by-products of the respective whey production processes, other proteins, gums or carbohydrates. The solution may also contain other food ingredients (fat, carbohydrates, plant extracts, etc). The amount of such additional compounds preferably does not exceed 50 wt. %, preferably 20 wt. %, and more preferably does not exceed 10 wt. % of the total weight of the solution.

The whey protein, as well as the fractions and/or the main proteins thereof may be used in purified form or likewise in form of a crude product. The content of divalent cations in the whey protein for the preparation of the whey protein micelles may be less than 2.5%, more preferably less than 2%, even more preferably less than 0.2%. Most preferably the whey proteins are completely demineralised.

PH and the ionic strength are important factors in the manufacture of whey protein micelles. Thus, for extensively dialyzed samples which are virtually devoid or depleted of free cations such as Ca, K, Na, Mg, it has been found that when performing the heat treatment during a time period of 10 s to 2 hours at a pH below 5.4, curd is obtained, while at a pH exceeding 6.8, soluble whey protein results. Thus, only in this rather narrow pH window will whey proteins micelles having a diameter of less than 1 μm be obtained. These micelles will have an overall negative charge. The same micelle form can also be obtained symmetrically below the isoelectrical pH, i.e from 3.5 to 5.0, more preferably 3.8 to 4.5, resulting in micelles being positively charged.

Thus, in order to obtain positively charged micelles, micellisation of whey proteins may be done in a salt free solution at a pH value adjusted between 3.8 and 4.5 depending on the mineral content of the protein source.

Preferably, the micelles used in the present invention will have an overall negative charge. Thus, the pH of the aqueous solution prior to heating is adjusted to a range of from 6.3 to 9.0, for a content in divalent cations comprised between 0.2% and 2.5% in whey protein powder.

More specifically, to obtain negatively charged micelles, the pH is adjusted to a range of from 5.6 to 6.4, more preferably from 5.8 to 6.0 for a low divalent cation content (e.g. less than 0.2% of the initial whey protein powder). The pH may be increased up to 8.4 depending on the mineral content of whey protein source (concentrate or isolate). In particular, the pH may be between 7.5 to 8.4, preferably 7.6 to 8.0 to obtain negatively charged micelles in the presence of large amounts of free minerals and the pH may be between 6.4 to 7.4, preferably 6.6 to 7.2 to obtain negatively charged micelles in the presence of moderate amounts of free minerals. As a general rule, the higher the calcium and/or magnesium content of the initial whey protein powder, the higher the pH of micellisation.

In order to standardise the conditions of formation of whey protein micelles, it is most preferable to demineralise by any of the known demineralisation techniques (dialysis, ultrafiltration, reverse osmosis, ion exchange chromatography . . . ), any source of liquid native whey proteins with a protein concentration ranging from that of sweet whey, microfiltration permeate of milk or acid whey (0.9% protein content) to that of a concentrate at 30% protein content. The dialysis can be done against water (distilled, deionised or soft), but as this will only allow removal of the ions weakly bound to the whey proteins, it is more preferable to dialyse against an acid at pH below 4.0 (organic or inorganic) to better control the ionic composition of the whey proteins. By doing so, the pH of whey protein micelle formation will be below pH 7.0, more preferably comprised between 5.8 to 6.6.

Prior to heating the whey protein aqueous solution, the pH is generally adjusted by the addition of acid, which is preferably food grade, such as e.g. hydrochloric acid, phosphoric acid, acetic acid, citric acid, gluconic acid or lactic acid. When the mineral content is high, the pH is generally adjusted by the addition of alkaline solution, which is preferably food grade, such as sodium hydroxide, potassium hydroxide or ammonium hydroxide.

Alternatively, if no pH adjustment step is desired, it is possible to adjust the ionic strength of the whey protein preparation while keeping the pH constant. Then, ionic strength may be adjusted by organic or inorganic ions in such a way that allows micellisation at a constant pH value of 7.

A buffer may be further added to the aqueous solution of whey protein so as to avoid a substantial change of the pH value during heat treatment of the whey protein. In principle, the buffer may be selected from any food-grade buffer system, i.e. acetic acid and its salts, such as e.g. sodium acetate or potassium acetate, phosphoric acid and salts thereof, e.g. NaH₂PO₄, Na₂HPO₄, KH₂PO₄, K₂HPO₄, or citric acid and salts thereof etc.

Adjusting the pH and/or the ionic strength of the aqueous solution, results in a controlled process yielding micelles having a size between 100 nm-900 nm, preferably between 100-700 nm, most preferably between 200-400 nm. Preferably, the distribution of micelles having dimensions between 100-700 nm is greater than 80% when carrying out the process of micellisation described herein.

In order to obtain regular shape micelles, it is also important, according to the invention, that the whey protein does not undergo any hydrolysation step prior to micelle formation.

In a second step of the process for forming whey protein micelles, the starting whey protein aqueous solution is then subjected to the heat treatment. In this respect, it has been found that for obtaining whey protein micelles, it is important to have the temperature in the range of from about 70 to below 95° C., preferably of from about 82 to about 89° C., more preferably of from about 84 to about 87° C., most preferred at about 85° C. It has also been found that, on an industrial scale, it is important that the temperature be preferably less than 95° C., more preferably between 80° C. and 90° C., most preferably about 85° C.

Once the desired temperature has been reached, the whey protein aqueous solution is kept at this temperature for a minimum of 10 seconds and a maximum of 2 hours. Preferably, the time period during which the aqueous whey protein solution is kept at the desired temperature ranges from 12 to 25 minutes, more preferably from 12 to 20 minutes, or most preferably about 15 minutes.

Turbidity measurements are an indication of micelle formation. The turbidity measured by absorbance at 500 nm may be at least 3 absorbance units for 1% protein solution but can reach 16 absorbance units when the yield of micellisation is above 80%.

To further illustrate the effect of micelle formation from a physicochemical point of view, a 1 wt % dispersion of Bipro® has been heated for 15 minutes at 85° C. at pH 6.0 and 6.8 in MilliQ water. The hydrodynamic diameter of the aggregates obtained after heat treatment was measured by dynamic light scattering. The apparent molecular weight of the aggregates was determined by static light scattering using the so-called Debye plot. The surface hydrophobicity was probed using the hydrophobic ANS probe and the free accessible thiol groups by the DTNB method using cystein as the standard amino acid. Finally, the morphology of the aggregates was studied by negative staining TEM. The results are presented in table 1.

TABLE 1
Physicochemical properties of soluble whey protein aggregates obtained by heat treatment
(85° C., 15 min) of a 1 wt % protein dispersion in presence or absence of NaCl.

| | hydrodynamic | molecular | | | protein surface | accessible |
|---|---|---|---|---|---|---|
| | diameter | weight M_{w} | | ζ-potential | hydrophobicity | SH groups |
| pH | (nm) | (×10⁶ g · mol⁻¹) | morphology | (mV) | (μg · mmol⁻¹ ANS) | (nmol SH · mg⁻¹ prot.) |
| 6.0 | 120.3 ± 9.1 | 27.02 ± 8.09 | Spherical | −31.8 ± 0.8 | 105.4 | 3.5 ± 0.4 |
| | | | micelles | | | |
| 6.8 | 56.2 ± 4.6 | 0.64 ± 0.01 | linear | −27.9 ± 1.2 | 200.8 | 6.8 ± 0.5 |
| | | | aggregates | | | |

From table 1, it is clear that the whey protein micelles that were formed at pH 6.0 allow protein to decrease its specific ANS surface hydrophobicity by a factor of 2 compared to non-micellised whey protein heated in the same condition, but at pH 6.8. The micelle formation can be also seen on the very high molecular weight of 27×10⁶ g·mol⁻¹ compared to 0.64×10⁶ g·mol⁻¹ for non-micellised protein, indicating a very condensed state of the matter within the micelle (low amount of water). Interestingly enough, the ζ-potential of the micelles is even more negative than the non-micellised proteins even if the latter have been formed at a more basic pH than the micelles. This is the result of a more hydrophilic surface of the micelles being exposed to the solvent. Finally, one should note that the thiol reactivity of the micelles is much lower than that of the non-micellised protein because of the different pH of heat treatment.

It has been found that the conversion yield of native whey protein to micelles decreases when the initial protein concentration is increased before pH adjustment and heat treatment. For example, when starting with a whey protein isolate Prolacta 90 (lot 673 from Lactalis), the yield of formation of whey protein micelles drops from 85% (when starting with 4% proteins) to 50% (when starting with 12% of proteins). In order to maximize the formation of whey protein micelles (>85% of the initial protein content), it may be better to start with an aqueous whey protein solution having a protein concentration below 12%, preferably below 4%. Depending on the intended final applications, the protein concentration may be adjusted before heat treatment to manage the optimal whey protein micelles yield.

The whey proteins micelles obtainable according to process described herein shall have a size with a diameter of less than 1 μm, preferably of from 100 to 990 nm, more preferably from 100 to 700 nm, most preferably from 200-400 nm.

Depending on the desired application, the yield of micelles may be of at least 50%, preferably at least 80% and the residual soluble aggregates or soluble protein content is preferably below 20%. The average micelle size is characterised by a polydispersity index below 0.200. It has been observed that whey protein micelles could form aggregates around pH 4.5, with however no sign of macroscopic phase separation after at least 12 hours at 4° C.

The purity of whey protein micelles can be obtained by determining the amount of residual soluble proteins. Micelles are eliminated by centrifugation at 20° C. and 26900 g for 15 min. The supernatant is used to determine the protein amount in quartz cuvettes at 280 nm (1 cm light pathlength). Values are expressed as a percentage of the initial value before heat treatment.

Proportion of micelles=(Amount of initial proteins−amount of soluble proteins)/Amount of initial proteins

The whey protein micelles obtainable according to a micellisation process described herein have not been submitted to any mechanical stress leading to reduction of the particle size during formation. This method induces spontaneous micellisation of whey proteins during heat treatment in the absence of shearing.

The whey protein micelles used in the present invention may be produced according to the process described herein but are not limited thereto.

The whey protein micelles may be used as such in the frozen dessert of the present invention. They may also be used in the form of a concentrate of whey protein micelles or a powder thereof. Furthermore the whey protein micelles may be filled with an active component. Said component may be selected from coffee, caffeine, green tea extracts, plant extracts, vitamins, minerals, bioactive agents, salt, sugar, sweeteners, aroma, fatty acids, oils, protein hydrolysates, peptides etc. and mixtures thereof.

Additionally, the whey protein micelles (pure or filled with active component) may be coated with an emulsifier such as phospholipids, for example, or other coating agents other coating agents such as a protein, a peptide, a protein hydrolysate or a gum such as acacia gum in order to modulate the functionality and the taste of the whey protein micelles. When a protein is used as a coating agent, it may be selected from any proteins having an isoelectric point significantly higher or lower than whey protein. These are, for example, protamine, lactoferrin and some rice proteins. When a protein hydrolysate is used as coating agent, it is preferably a hydrolysate from proteins such as protamine, lactoferrin, rice, casein, whey, wheat, soy protein or mixtures thereof. Preferably, the coating is an emulsifier selected from sulphated butyl oleate, diacetyltartaric acid esters of mono- and diglycerides, citric acid esters of monoglycerides, stearoyl lactylates and mixtures thereof. Furthermore, co-spraydrying, as described further herein, may also result in a coating of the whey protein micelles.

Thus, the whey protein micelle dispersion obtained after heat treatment may be concentrated to yield a whey protein micelle concentrate.

Concentration of the whey protein micelles may be carried out by evaporation, centrifugation, sedimentation, ultrafiltration and/or microfiltration, for example.

Evaporation may be carried out on the micelles by feeding the whey protein micelles obtained after heat treatment to an evaporator under vacuum, having a temperature between 50° C. and 85° C. The resulting product will generally have the aspect of a gel or a cream as shown in FIG. 8. The protein concentrate obtained by evaporation has a creamy, semi-solid texture and can be texturised in a spreadable texture by acidification using lactic acid. This liquid, creamy, pasty texture can be used to prepare acid, sweet, salty, aromatic, protein-rich frozen desserts.

Preferably, concentration of the whey protein micelles may be achieved by microfiltration of the micelles dispersion. This enriching technique not only enables to concentrate whey protein micelles by removing the solvent but also enables the removal of non-micellised protein (such as native proteins or soluble aggregates). Thus, the final product only consists of micelles (as checked by Transmission Electron Microscopy—cf. FIGS. 3 and 4). In this case, the concentration factor that is possible to achieve is obtained after the initial flow rate of permeate through the membrane has dropped to 20% of its initial value.

The whey protein concentrate thus obtained may have a protein concentration of at least 12%. Furthermore, the concentrate may contain at least 50% of the protein in the form of micelles. Preferably, at least 90% of the protein will be in the form of micelles.

The concentrate may be used as such or diluted depending on the intended frozen dessert.

For instance, the whey protein micelle concentrate in liquid or dried form may be diluted to a protein content of 9% like in sweet and condensed milk. The milk minerals, lactose and sucrose can be added so that the final product will have similar nutritional profile compared to milk, but only whey protein as the protein source.

The dried powder form of the whey protein micelles may be obtained by any known techniques, such as spray-drying, freeze-drying, roller drying etc. Thus, the whey protein micelles may be spray-dried or freeze-dried with or without addition of further ingredients and may be used as a delivery system or a building block to be used in the manufacture of the frozen dessert of the present invention.

FIG. 2 shows a powder obtained by spray-drying without addition of any further ingredients, having an average particle diameter size greater than 1 micron due to the micelle aggregation occurring during spray-drying. Such a whey protein powder having an average size greater than 1 micron may be used in the frozen dessert of the present invention. A typical average volume median diameter (D₄₃) of these powders is between 45 and 55 microns, preferably 51 microns. The surface median diameter (D₃₂) of the whey protein micelle powders is preferably between 3 and 4 microns, more preferably it is 3.8 microns.

The moisture content of the powders obtained after spray-drying is preferably less than 10%, more preferably less than 4%.

A whey protein micelle powder produced by spray-drying with or without addition of further ingredients may comprise at least 35% of whey protein micelles, up to at least 80% whey protein micelles.

Whey protein micelles powders have a high binding capacity for solvents such as water, glycerol, ethanol, oils etc. The binding capacity of the powders to water is at least 50%, preferably at least 90%, most preferably at least 100%. For solvents such as glycerol and ethanol, the binding capacity is of at least 50%. For oils, it is at least 30%. This property allows the powders to be sprayed or filled with further active agents and used in the frozen desserts of the present invention.

Such active agents may be selected from vitamins, minerals, antioxidants, poly-unsaturated fatty acids, peptides, plant extracts, protein hydrolysates, bioactives, aroma, sweeteners, sugars, polysaccharides, sucrose, supplements, pharmaceuticals, drugs, milk, milk proteins, skimmed milk powder, micellar casein, caseinate, vegetal protein, amino acids, pigment etc. and any possible mixtures thereof, cosmetic components, components sensitive to heat, UV radiation, light, oxygen, metals, humidity, temperature etc. Active agents may be unstable compounds such as polyphenols (from coffee, green tea etc.), lycopene and other carotenoids. They may include compounds such as caffeine, hesperidins, soluble or non-soluble salts, probiotic bacteria, stains, maltodextrins, fats, emulsifiers, ligands etc.

The active agents may be included in the powder in an amount of 0.1-50%. Thus, the powder may act as a carrier for those functional ingredients. This presents the advantage that, for instance, caffeine bitterness perception is reduced when, caffeine as an active agent is filled into the whey protein micelle powders and used in caffeinated frozen dessert for example.

Additional ingredients may be mixed with the whey protein micelle concentrate prior to spray-drying. These comprise soluble or non-soluble salts, probiotic bacteria, stains, sugars, maltodextrins, fats, emulsifiers, sweeteners, aroma, plant extracts, ligands or bioactives (caffeine, vitamins, minerals, drugs . . . ) and any mixtures thereof. The resulting mixed whey protein micelle powders comprise whey protein micelles and additional ingredients in a weight ratio ranging from 1:1 to 1:1000. In this case, the whey protein micelle powder obtained may also act as a carrier for active agents, in the frozen dessert of the invention.

This co-spraydrying results in powders consisting of whey protein micelles agglomerated or coated with an additional ingredient. Preferably, the weight ratio of whey protein micelles to additional ingredient is 1:1. This may further facilitate solubilisation of these powders and may be of particular interest in ice cream manufacture.

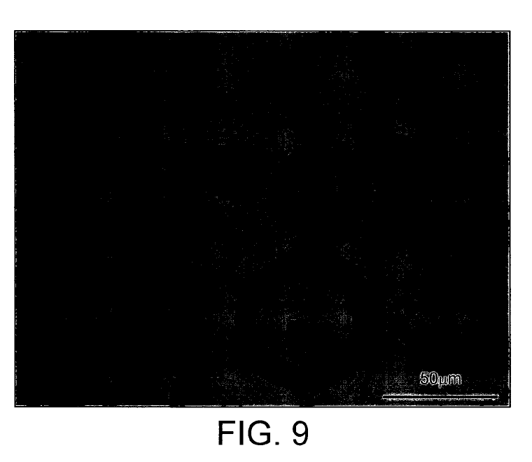

The whey protein micelle powders obtainable by the process described herein are characterised by an internal structure composed mainly of hollow spheres but also of collapsed spheres (cf. FIG. 9). The hollow spheres structure can be easily explained by the formation of the vapour droplet within the WPM concentrate droplet during the spray drying. As the vapour droplet left the WPM droplet due to a temperature above 100° C., a hollow sphere remained. The “boneshape” is due to a combination of the water evaporation from droplet and the external pressure within the droplet.

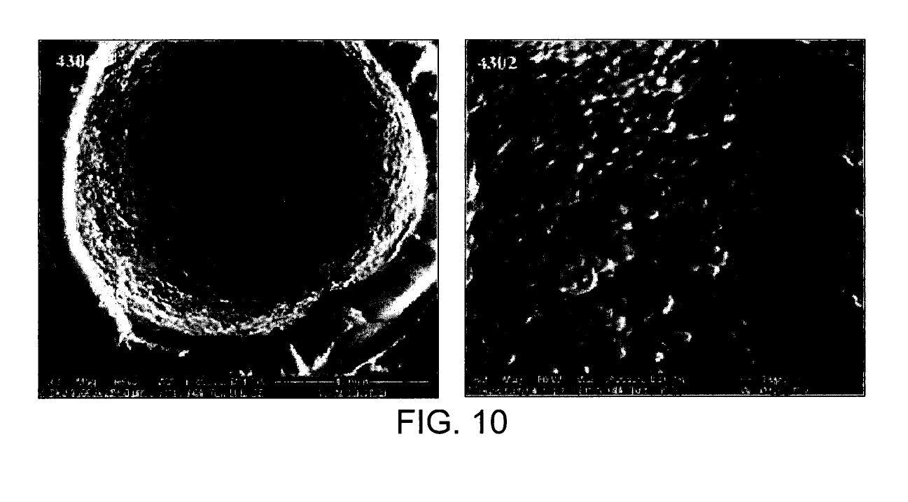

The internal structure of the spherical hollow spheres was investigated by SEM after sectioning the particle close to its diameter (FIG. 10, left). The wall thickness of the particle was around 5 μm and seemed very smooth, whereas the inner structure had a more grainy appearance. Increased magnification showed that this graininess was in fact due to the presence of the initial WPM that were fused to form the inner matrix of the powder particle. Interestingly, the spherical shape of the micelles was kept during spray-drying as well the homogeneous particle size distribution (FIG. 10, right).

Thus, on a microscopic basis, whey protein micelle powders are characterised by a unique granule morphology of hollow or collapsed spheres containing intact and individualised whey protein micelles.

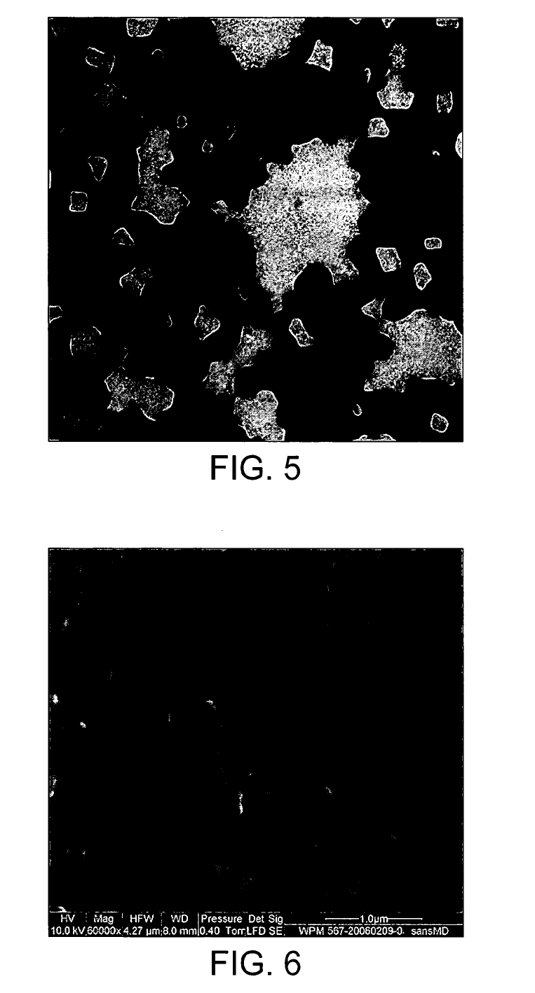

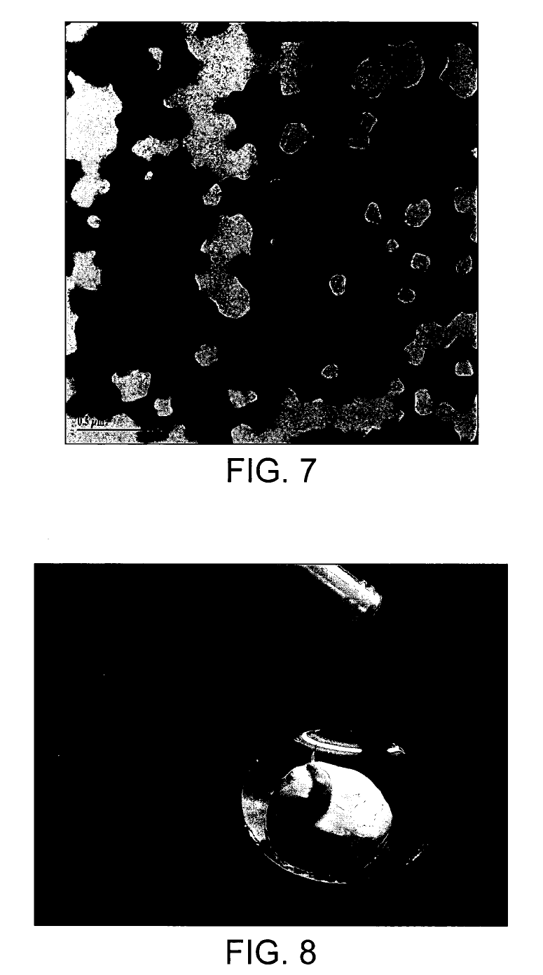

An important feature of these whey protein micelle powders is that the basic micelle structure of the whey proteins is conserved. FIG. 6 shows a whey protein powder grain which has been sectioned, and whereby the individual whey protein micelles are observable. Furthermore, the micelle structure can be easily reconstituted in solvents. It has been shown that the powders obtained from whey protein micelle concentrate can be easily redispersed in water at room temperature or at 50° C. The size and structure of the whey protein micelles are fully conserved compared to the initial concentrate. For example, in FIG. 5, the whey protein concentrate that was spray-dried at 20% protein concentration has been redispersed in deionised water at 50° C. at a protein concentration of 50%. The structure of the micelles has been probed by TEM and can be compared to FIG. 4. A similar shape of micelles was obtained. The diameter of the micelles was found to be 315 nm by dynamic light scattering with a polydispersity index of 0.2. FIG. 7 also shows dispersion of a freeze-dried whey protein micelle powder, wherein the micelles are reconstituted.

The fact that the whey protein micelles and only a minor aggregated fraction were observed in solution after reconstitution of the spray-dried or freeze-dried powder confirms that whey protein micelles are physically stable regarding spray-drying, freeze-drying etc.

The whey protein micelles used in the present invention in any of the forms disclosed herein have shown to be ideally suited for use as an emulsifier, fat substitute, substitute for micellar casein or foaming agent, since they are able to stabilize fat and/or air in an aqueous system for prolonged period.

Thus, whey protein micelles may be used as an emulsifying agent, for which the material is ideally suited, since it has a neutral taste and no off-flavour is created by the use of such material. They may also be used as micellar casein substitute.

In addition, whey protein micelles are in a condition to serve as whitening agent, so that with one compound several tasks may be fulfilled. The whitening power of the concentrate is tremendously increased in comparison to the native protein powders. For example, the whitening power of 4 mL of a 15% whey protein micelle concentrate is equivalent to 0.3% of titanium oxide in 100 mL of a 2% soluble coffee cup.

As well as increasing the whitening power of dairy systems for the same total protein content, the fat content in a food matrix may be reduced. This feature represents a particular advantage of the use of whey protein micelles, since it allows to produce frozen desserts having a low fat content.

Furthermore, the whey protein micelles may be used either alone or together with other active materials, such as polysaccharides (e.g. acacia gum or carrageenans) to stabilise matrices and for example milky foam matrices. Due to their neutral taste, their whitening power and their stability after heat treatment, whey proteins micelles may be used to increase skimmed milk whiteness and mouthfeel.

Since whey is a material abundantly available, the use thereof reduces the cost of a product requiring an emulsifying, filling, whitening or foaming agent, while at the same time adding to its nutritional value. Indeed, the micelles used in the present invention have a Protein Efficiency Ratio equivalent to the starting whey protein of at least 100, preferably at least 110, which makes them important nutritional ingredients.

Accordingly, whey protein micelles may be used in any form described herein for the preparation of any kind of frozen dessert according to the present invention, such as e.g. ice-creams, milkshakes, smoothies, sorbets, water ice, mellorine, soft-ice, etc.

However, the frozen desserts of the present invention are not exclusively limited to the use of whey protein micelles.

Thus frozen desserts containing more than 6% protein, preferably more than 10% protein may be obtained. Additionally, since whey protein micelles may act as a fat substitute while maintaining desirable structural, textural and organoleptic properties, a wider variety of low-fat products may be obtained.

Accordingly, whey protein micelles may be comprised in the pasteurised frozen dessert of the present invention. Due to the presence of whey protein micelles which are very stable to processing in comparison with native proteins, high protein pasteurised frozen desserts may be obtained. The protein source is however not limited to whey protein micelles only and these may be used in combination with other protein sources.

Thus, according to an embodiment, a pasteurized frozen dessert, having more than 6%, preferably more than 8%, most preferred more than 10% protein content and an essentially neutral pH value, preferably between 6 and 8, wherein the fat caloric value is less than 45% is provided.

At least a portion of the protein content in the ice cream of the present invention may be present as whey protein micelles. However, the protein source in the present frozen desserts is not limited thereto and may be selected from whey protein isolates, whey protein concentrates, whey protein micelles, micellar casein, milk protein isolates, skimmed milk powders and any combinations thereof.

In some embodiments, the protein content comprises casein and whey protein in a ratio of from between 0-100 to 80-20. Preferably, the protein content consists essentially of whey proteins. The whey proteins are at least partially present in the form of whey protein micelles. In a preferred embodiment, whey protein micelles constitute at least 50% of the total protein content of the frozen dessert.

In the frozen desserts of the invention, at least 15% to 300% of the energy is provided by proteins, between 0% and 45% of the energy is provided by fat, and between 25% and 85% of the energy is provided by carbohydrates. Preferably the fat caloric value is less than 35%. In some embodiments, the fat caloric value may be less than 25%, even less than 20%, and in particular less than 10%.

Preferably, the nutritional profile of the frozen desserts of the present invention may be comparable to that of a glass of milk (when expressed in absolute numbers and/or in percentages).

When used in the frozen desserts of the present invention, the whey protein micelles may be provided in the form of a suspension, a concentrate or a powder, all these forms having been described above. The whey protein micelles may have an average size smaller than 1 micron, preferably between 100-900 nm. If powders of whey protein micelles are used, these may have an average size greater than 1 micron. Furthermore, the whey protein micelle powder may act as a carrier or delivery vehicle for active agents.

The frozen desserts of the present invention may be any frozen desserts selected from ice cream, milk shake, sorbet, mellorine, smoothy, water ice, soft-ice etc. They may be aerated. When aerated, they may have an overrun of 20% to 200%, preferably of 70% to 150%, depending on the intended frozen dessert.

The frozen dessert may comprise milk fat, one or more vegetable fats or mixtures thereof. Alternatively, it may contain no fat. Preferably, it comprises fat. Most preferably, the fat is milk fat.

A pasteurised frozen ice cream of the invention has per weight at least 8% proteins, 15% to 28% carbohydrates, and 3% to 7% fat. Preferably, it comprises 8-12% proteins, 15-20% carbohydrate and 5-7% fat. More preferably, the ice cream has a protein content of more than 10%. In some cases, it may have a protein content even more than 12%. Alternatively, the carbohydrate content may be between 20% to 26% and the fat content may be of 4% to 6%.

The carbohydrate source may be selected from lactose, sucrose, glucose, maltose etc.

The invention thus provides new frozen desserts which are nutritious and may be consumed as a healthy snack, on a daily basis.

The frozen desserts of the present invention have good sensory qualities, a creamy texture, while being nutritionally balanced. They may further contain other agents beneficial to health such as vitamins, minerals, probiotics, prebiotics, inclusions etc.

In a preferred embodiment, the frozen confections of the invention have a calcium content of 0.1-1%, more preferably 0.2-0.5%, most preferably 0.3-0.4%.

They may further comprise phosphorus in an amount of 0.1-0.5%, more preferably 0.2-0.4%, most preferably 0.25-0.35%.

When whey protein micelles are used in the manufacture of the frozen desserts of the present invention, a first step of blending a mix of ingredients comprising whey protein micelles, concentrates thereof or powders thereof is carried out. The whey protein micelles preferably have an average size of between 100 nm-900 nm. If a whey protein micelle powder is used, the average size of said powder is preferably greater than 1 micron.

Preferably the whey protein micelle content in the blend on a dry matter basis will be 10-40%, preferably, 15-35%, more preferably 30%. The frozen dessert thus produced may have a protein content greater than 6%, preferably greater than 8%.

Other ingredients of the blend may be any ingredients used in the manufacture of frozen desserts, such as MSNF, emulsifiers, sugars, fat source, aroma, stabilisers, inclusions, other protein sources etc.

The blend is then pasteurised at a temperature between 80° C. and 87° C. for a time period of at least 10 s. Preferably, pasteurisation is carried out at an essentially neutral pH value, for instance between 6 and 8. Pasteurisation may also be carried out at a moderate acid pH between 4 and 6, for instance if natural fruit (pulp or juice) is added to the blend. Optionally, a fruit based acid blend can be added after pasteurisation.

The pasteurised blend may then be homogenised prior to freezing at a temperature of 50° C. After homogenisation, the blend may also be left to mature or “age” for up to 24 hours prior to freezing.

The high protein frozen dessert may then be associated to a fruit-based layer, in a two-layer frozen dessert or may comprise a fruit-based coating.

The frozen dessert thus produced will preferably have a protein content greater than 6%, more preferably greater than 8%.

By this process, frozen desserts having a high protein content, excellent sensory qualities and a balanced nutritional profile may be obtained.

In the present invention, any disclosure of list of ingredients is intended to disclose any possible combination of said ingredients, in any possible ratio.

In the present invention, when the protein, fat or carbohydrate contents and/or calorific values of the frozen dessert are mentioned, these values refer to the matrix of the frozen dessert and do not include additional ingredients which may be present in the frozen dessert matrix, such as coatings, inclusions, etc.

The following examples illustrate the present invention without limiting it thereto.

### EXAMPLES

The following examples describe the preparation of micelles which can be optionally used in the context of the present invention. They further describe recipes used for the manufacture of nutritionally balanced frozen confections.

### Example 1

### Micellisation of β-Lactoglobulin

β-Lactoglobulin (lot JE002-8-922, 13 Dec. 2000) was obtained from Davisco (Le Sueur, Minn., USA). The protein was purified from sweet whey by ultra-filtration and ion exchange chromatography. The composition of the powder is 89.7% protein, 8.85% moisture, 1.36% ash (0.079% Ca²⁺, 0.013% Mg²⁺, 0.097% K⁺, 0.576% Na⁺, 0.050% Cl⁻). All other reagents used were of analytical grade (Merck Darmstadt, Germany).

The protein solution was prepared at 0.2% concentration by solvation of β-lactoglobulin in MilliQ® water (Millipore), and stirring at 20° C. for 2 h. Then pH of aliquots was adjusted to 5.0, 5.2, 5.4, 5.6, 5.8, 6.0, 6.2, 6.4, 6.6, 6.8, 7.0 by HCl addition. The solutions were filled in 20 ml glass vials (Agilent Technologies) and sealed with aluminum capsules containing a silicon/PTFE sealing. The solutions were heated at 85° C. for 15 min (time to reach the temperature 2.30-3.00 min). After the heat treatment, the samples were cooled in ice water to 20° C.

The visual aspect of products indicates that the optimal pH of micellisation is 5.8.

### Example 2

### Micellisation of Whey Protein Isolate

Whey protein isolate (WPI) (Bipro®, Batch JE032-1-420) was obtained from Davisco (Le Sueur, Minn., USA). The composition of the powder is reported in table 2.

The protein solution was prepared at 3.4% protein by solvation of whey protein powder in MilliQ® water (Millipore), and stirring at 20° C. for 2 h. The initial pH was 7.2. Then pH of aliquots was adjusted at 5.6, 5.8, 6.0, 6.2, 6.4 and 6.6 by HCl 0.1N addition.

The solutions were filled in 20 ml glass vials (Agilent Technologies) and sealed with aluminum capsules containing a silicon/PTFE sealing. The solutions were heated at 85° C. for 15 min (time to reach the temperature 2.30-2.50 min). After the heat treatment, samples were cooled in ice water to 20° C.

The turbidity of heated whey proteins has been determined at 500 nm and 25° C., samples were diluted to allow the measurement in the range of 0.1-3 Abs unit (Spectrophotometer Uvikon 810, Kontron Instrument). Values were calculated for the initial protein concentration 3.4%.

The pH of micellisation was considered to be reached upon stability (less than 5% variation of the initial value) of the absorbance measured at 500 nm within an interval of 10 minutes for the same sample. For this product the optimal pH for micellisation was 6.0 to 6.2. For this pH adjusted before heat treatment stable turbidity was 21 and residual soluble protein evaluated by absorbance at 280 nm after centrifugation was 1.9%. We can conclude that 45% of initial proteins were transformed in micelles at pH 6.0.

TABLE 2
Composition of WPI and sample characteristics after micellisation

| | |
|---|---|
| Supplier | Davisco |
| Product name | Bipro |
| Batch number | JE 032-1-420 |
| Composition (mg/100 g) | |
| Sodium | 650 |
| Potassium | 44 |
| Chloride*10 if ≦40 | 10 |
| Calcium | 82 |
| Phosphorus | 49 |
| Magnesium | 6 |
| Initial pH | 7.2 |
| pH micellisation | 6.0 |
| Turbidity (500 nm) for 3.4% protein in | 21 |
| solution | |
| Residual Soluble protein (%) by | 1.9 |
| absorbance at 280 nm | |

### Example 3

### Whey Protein Enriched Low-Fat Ice Cream

### Material

Whey protein isolate (WPI, Prolacta90® from Lactalis, Rétiers, France) with a protein content of 90%
Skim milk powder with 35% protein content

### Sucrose

### Maltodextrins DE39

Anhydrous milk fat

### Emulsifier

De-ionised water
Edible hydrochloric acid 1M

### Method Using In-Line Generation of Whey Protein Micelles

Using a double-jacketed 80 L tank, the Prolacta90® powder was dispersed at 50° C. in de-ionized water at a protein concentration of 11.6 wt % under gentle stirring in order to avoid foam formation. After 1 hour of dispersion, the pH of the dispersion was adjusted to the micellisation pH by addition of HCl. The temperature of the dispersion was raised to 85° C. and maintained for 15 minutes in order to generate the whey protein micelles. After 15 minutes, the temperature was decreased to 50° C. and the additional ingredients were sequentially added to the micelles dispersion (i.e. skim milk powder, maltodextrins DE39, sucrose, emulsifier and anhydrous milk fat). The final amount of mix was 50 kg with total solids content of 39.4% and a fat content of 5 wt %. After 30 minutes of hydration, the mix was two-step homogenised (80/20 bars) and pasteurised (86° C./30 s) before ageing during overnight.

The day after, the ice-cream mix was frozen at an overrun of 100% using a Hoyer MF50 apparatus and hardened at −40° C. before storage at −20° C. The final ice cream contained 10 wt % proteins (17% caseins, 83% whey proteins) and 5 wt % fat on the ice cream mix basis. The caloric contribution of this ice cream is 51.4% from sugar, 27.9% from fat and 20.7% from proteins.

### Method Using Powdered Whey Protein Micelles

Using a double-jacketed 80 L tank, the whey protein micelle powder was dispersed at 50° C. in de-ionized water under gentle stirring in order to avoid foam formation. After 15 minutes of dispersion, the additional ingredients were sequentially added to the whey protein micelles dispersion (i.e. skim milk powder, maltodextrins DE39, sucrose, emulsifier/stabilizers and anhydrous milk fat). The final amount of mix was 50 kg with total solids content of 37.5% and a fat content of 5 wt %. After 30 minutes of hydration, the mix was two-step homogenised (80/20 bars) and pasteurised (86° C./30 s) before ageing during overnight.

The day after, the ice-cream mix was frozen at an overrun of 100% using a Hoyer MF50 apparatus and hardened at −40° C. before storage at −20° C. The final ice cream contained 12.8 wt % proteins (13% caseins, 87% whey proteins) and 5 wt % fat on the ice cream mix basis. The caloric contribution of this ice cream is 44.9% from the sugar, 29.4% from the fat and 25.7% from the proteins.

### Example 4

### Powdered Whey Protein Micelles Obtained by Spray-Drying

### Material

Whey protein isolate (WPI, Prolacta90® from Lactalis, Rétiers, France) with a protein content of 90%
Edible lactose

### Maltodextrins DE39

De-ionised water
Edible hydrochloric acid 1M

### Method

Using a double-jacketed 100 L tank, the Prolacta90® powder was dispersed at 50° C. in de-ionized water at a protein concentration of 10 wt % under gentle stirring in order to avoid foam formation, i.e. 11 kg of Prolacta90® were dispersed in 89 kg of de-ionised water. After 1 hour of dispersion, the pH of the dispersion was adjusted to the micellisation pH (around 6.3 in that case) by addition of HCl. The temperature of the dispersion was raised to 85° C. and maintained for 15 minutes in order to generate the whey protein micelles. After 15 minutes, the temperature was decreased to 50° C. and the 10 wt % whey protein micelles dispersion was split in two batches of 50 kg. In a first trial, 20 kg of lactose were dispersed in 50 kg of micelles dispersion at 50° C. and stirred for 30 min. Similarly, 20 kg of maltodextrins DE39 were added to the remaining 50 kg of whey protein micelles dispersion.

The two mixtures were then spray dried into a NIRO SD6.3N tower at a flow rate of 15 L/h. The air input temperature was 140° C. and the air output temperature was 80° C. The water content of the obtained powders was lower than 5%.

The size of the whey protein micelles was determined in presence of lactose and maltodextrin (DE39) in water using dynamic light scattering before and after spray drying. The total protein concentration was set to 0.4 wt % by dilution of the dispersion before spray drying or reconstitution of the powder in order to be in the dilute regime of viscosity for whey protein micelles. A Nanosizer ZS apparatus (Malvern Instruments) was used and micelle diameter was averaged from 20 measurements.

The particle diameter determined for whey protein micelles in presence of lactose and maltodextrins (DE39) was 310.4 nm and 306.6, respectively. After reconstitution of the powders, the respective diameters were found to be 265.3 nm and 268.5, respectively. These measurements confirm than whey protein micelles were physically stable regarding spray drying. The results were corroborated by TEM microscopy observations of 0.1 wt % whey protein micelles dispersions in water using negative staining in presence of 1% phosphotungstic acid at pH 7. A Philips CM12 transmission electron microscope operating at 80 kV was used. Whey protein micelles were observed in solution before spray drying and after reconstitution of the spray-dried powder. No difference of morphology and structure could be detected.

### Example 5

### Concentration by Evaporation

A whey protein isolate Prolacta 90 from Lactalis (lot 500648) has been reconstituted at 15° C. in soft water at a protein concentration of 4% to reach a final batch size of 2500 kg. The pH was adjusted by addition of 1M hydrochloric acid so that the final pH value was 5.90. The whey protein dispersion was pumped through plate-plate APV-mix heat exchanger at a flow rate of 500 l/h. Pre-heating at 60° C. was followed by heat treatment of 85° C. for 15 minutes. Formation of whey protein micelles was checked by measurement of particle size using dynamic light scattering as well a turbidity measurement at 500 nm. The obtained 4% whey protein micelles dispersion was characterised by a hydrodynamic radius of particles of 250 nm, a polydispersity index of 0.13 and a turbidity of 80. The whey protein micelle dispersion was then used to feed a Scheffers evaporator at a flow rate of 500 l/h. The temperature and vacuum in the evaporator were adapted so that around 500 kg whey protein micelles concentrate having a protein concentration 20% were produced and cooled down to 4° C.

### Example 6

### Enrichment by Microfiltration

A whey protein isolate Prolacta 90 from Lactalis (lo 500648) has been reconstituted at 15° C. in soft water at a protein concentration of 4% to reach a final batch size of 2500 kg. The pH was adjusted by addition of 1M hydrochloric acid so that the final pH value was 5.90. The whey protein dispersion was pumped through plate-plate APV-mix heat exchanger at a flow rate of 500 l/h. A pre-heating at 60° C. was followed by heat treatment of 85° C. for 15 minutes. Formation of whey protein micelles was checked by measurement of particle size using dynamic light scattering as well a turbidity measurement at 500 nm. The obtained 4% whey protein micelles dispersion was characterised by a hydrodynamic radius of particles of 260 nm, a polydispersity index of 0.07 and a turbidity of 80. The micelle form of the protein was also checked by TEM, and micelle structures with an average diameter of 150-200 nm were clearly visible (FIG. 3). The whey protein micelle dispersion could be cooled at 4° C. for storage or directly used to feed a filtration unit equipped with a 6.8 m² Carbosep M14 membrane at a flow rate of 180 l/h. In that case, the concentration of the whey protein micelles was performed at 10 to 70° C. until the permeate flow rate reached 70 l/h. In that case, the final whey protein concentrate contained 20% of proteins. The structure of the micelles in the concentrate was checked by TEM, and clearly no significant change was visible compared to the 4% whey protein dispersion before microfiltration (FIG. 4).

### Example 7

### Whey Protein Micelles Powder Comprising at Least 90% Whey Protein

200 kg of a whey protein micelle concentrate obtained by microfiltration at 20% protein (see example above) were injected in a Niro SD6.3N tower using an atomisation nozzle (Ø=0.5 mm, spraying angle=65°, pressure=40 bars) at a product flow rate of 25 kg/h. The inlet temperature of product was 150° C. and the outlet temperature was 75° C. The airflow in the tower was 150 m³/h. The moisture content in the powder was less than 4% and the powder was characterized by a very high flowability. Scanning electron microscopy of the powder exhibited very spherical particles having an apparent diameter ranging from 10 to 100 μm (FIG. 2).

### Example 8

### Mixed Whey Protein Micelle Powder

20 kg of a whey protein micelle concentrate were mixed with 1.7 kg of maltodextrins with a DE of 39 so that the final whey protein micelle to maltodextrin ratio in powder is 70/30. This mixture was injected in a Niro SD6.3N tower using an atomisation nozzle (Ø=0.5 mm, spraying angle=65°, pressure=40 bars) at a product flow rate of 25 kg/h. The inlet temperature of product was 150° C. and the outlet temperature was 75° C. The airflow in the tower was 150 m³/h. The moisture content in the powder was less than 4% and the powder was characterized by very high flow ability.

The powders of examples 7 and 8, when reconstituted in water, comprise essentially micelles having the same structure and morphology as the whey protein micelle concentrate.

### Example 9

### Whey Protein Micelle Powder Obtained by Freeze-Drying

### Material

Whey protein micelle concentrate at 20% protein produced by microfiltration in example 6 with a protein content of 90%

### Method

100 g of whey protein micelles concentrate were introduced in a plastic beaker and frozen at −25° C. for one week. This beaker was then placed in a lab-scale freeze drier Virtis equipped with a vacuum pump. Sample was left for 7 days until the pressure in the freeze drier remained constant at about 30 mbars. Around 20 g of freeze-dried whey protein micelles has been recovered.

### Example 10

### Aqueous Dispersion of Whey Protein Micelles Coated with Sulfated Butyl Oleate (SBO) or Any Other Negatively Charged Emulsifier

### Material

Whey protein micelle (WPM) powder from example 7 with a protein content of 90%

### SBO

Hydrochloric acid (1M)

### Method

WPM powder described in example 7 is dispersed in MilliQ water to achieve a final protein concentration of 0.1 wt %. This dispersion is filtered on 0.45 μm filters in order to remove possible WPM aggregates. The pH of this WPM dispersion was brought down to 3.0 by addition of hydrochloric acid 1M. A 1 wt % dispersion of SBO is prepared at pH 3.0.

The hydrodynamic radius and zeta potential of these WPM was determined using the Nanosizer ZS apparatus (Malvern Instruments Ltd.). Diameter was 250 nm and electrophoretic mobility+2.5 μm·cm·V⁻¹·s⁻¹. The hydrodynamic radius and electrophoretic mobility of the SBO dispersion at pH 3.0 are 4 nm and −1.5/−2.0 μm·cm·V⁻¹·s⁻¹ respectively.

After having performed this preliminary characterization, the SBO dispersion is used to titrate the WPM one, while following evolution of hydrodynamic radius and electrophoretic mobility of the mixture. It was found that the hydrodynamic radius was constant around 250-300 nm until a WPM/SBO weight-mixing ratio of 5:1 was reached. At this point, the hydrodynamic radius diverges dramatically to 20000 nm and precipitation of complexes WPM SBO is encountered. Upon further addition of SBO, higher than a mixing ratio of 5:1, the hydrodynamic progressively decreased to 250 nm, as found initially for WPM, levelling of from a ratio of 4:1 on. Following the electrophoretic mobility of the mixture showed that it decreased upon addition of SBO, reaching zero value for a mixing ratio of 5:1. Then it continued to drop upon SBO addition, starting levelling of at −3.0 μm·cm·V⁻¹·s⁻¹ from ratio 4:1 on.

The explanation for these results is that the positively charged WPM are, in a first step coated electrostatically with the negative head of the SBO until full charge neutralisation is achieved (mixing ratio 5:1). At this point, the hydrophobic tails from the SBO are able to self-associate, leading to over-aggregation with very large hydrodynamic diameter and precipitation of complexes. Upon further addition of SBO, the hydrophobic tails associate further to form a double coating, exposing their negative head to the solvent. This lead to negatively charged WPM with a double coating of SBO comparable to a full protein core liposome.

Similar results have been obtained with other acidic food grade Emulsifiers such as DATEM, CITREM, SSL (from Danisco) in aqueous solution at pH 4.2 where they are mainly ionized in their anionic form (—COO⁻ chemical functions).

### Example 11

### Recipes of Nutritionally Balanced Ice Cream

The following examples show recipes of nutritionally balanced ice cream. All samples were processed using standard ice cream manufacturing procedures, were frozen at −5° C. and had an overrun of 100%. Pasteurisation treatment of the mixes was carried out at 86° C. for 30 s.

WPM concentrate: whey protein micelles concentrate was obtained by heat treatment of 4.4% TS Prolacta 90 (native whey protein) dispersed in soft water at pH 5.9 at 85° C. for 15 minutes. Subsequently, a microfiltration step was carried out at 55° C. until 20% TS proteins was reached. The concentrate was stored at 4-10° C.

WPM powder: whey protein micelles powder was obtained by spray drying of the liquid concentrate using NIRO tower. The powder contains 3.5% moisture and was stored in sealed aluminium bags at 10° C.

Recipes 1-5

| Ingredients | Recipe 1 | Recipe 2 | Recipe 3 | Recipe 4 | Recipe 5 |
|---|---|---|---|---|---|
| SMP | 10.0 | 4.0 | | 2.0 | |
| WPI or WPM | 1.4 | | | 1.6 | 12 |
| MPI | | 11.0 | 13.0 | 4.0 | |
| MC | 7.0 | | | 6.1 | |
| Sucrose | 14.0 | 14.0 | 14.0 | 14.0 | 19.0 |
| Fat | 5.0 | 5.0 | 5.0 | 5.0 | 5.0 |
| TS (%) | 37.5 | 34.0 | 32.0 | 32.7 | 36.0 |
| Protein (wt %) | 10.8 | 10.8 | 11.1 | 10.7 | 10.8 |
| Sugar (wt %) | 20.5 | 16.7 | 14 | 15.3 | 19 |
| Fat (wt %) | 5.1 | 5.1 | 5.1 | 5.1 | 5.1 |
| Calcium (wt %) | 0.2-0-4 | 0.2-0.4 | 0.2-0.4 | 0.2-0.4 | 0.01-0.4 |
| Calories from protein (%) | 25.4 | 27.8 | 30.4 | 28.8 | 26.3 |
| Calories from sugar (%) | 48.2 | 43.0 | 38.6 | 41.0 | 46.3 |
| Calories from fat (%) | 26.4 | 29.1 | 31.0 | 30.2 | 27.4 |

SMP: skimmed milk powder
WPI: whey protein isolates
WPM: whey protein micelles
MPI: milk protein isolates
MC: micellar casein
TS: total solids

Using a variety of combination of protein sources, high protein balanced ice cream could be produced.

Recipes A-C

| | Ice cream A | Ice cream B | Ice cream C |
|---|---|---|---|
| SMP | 11.00 | 11.00 | 11.00 |
| Micellar caseins | 0.00 | 9.60 | 0.00 |
| (85% protein) | | | |
| WPM powder (90% protein) | 9.00 | 0.00 | 9.00 |
| Maltodextrins | 1.00 | 1.00 | 0.00 |
| Sugars | 12.00 | 12.00 | 13.00 |
| Butter fat | 5.00 | 5.00 | 5.00 |
| Stabilisers/Emulsifiers | 0.30 | 0.30 | 0.30 |
| Flavours | 0.34 | 0.34 | 0.34 |
| Proteins | 11.95 | 12.01 | 11.95 |
| Water | 61.36 | 60.76 | 61.36 |
| Total | 100.00 | 100.00 | 100.00 |
| TS (total solids) | 38.64 | 39.24 | 38.64 |
| Overrun | 100.00 | 100.00 | 100.00 |
| Proteins (% cal) | 25.68 | 25.68 | 25.68 |
| Sugars (% cal) | 44.08 | 44.08 | 44.08 |
| Fat (% cal) | 30.25 | 30.25 | 30.25 |

It was possible to produce balanced ice creams using as a protein source the whey protein micelle powder of the invention with skimmed milk powder (ice cream A and C) or micellar casein with skimmed milk powder (ice cream B).

Recipes 6-8

| | | | 8 |
|---|---|---|---|
| | 6 | 7 | 12% protein IC |
| | 12% Proteins | 5% Proteins | (70% WPM- |
| | 100% WPM | 100% SMP | 30% SMP) |
| SMP | 0.00 | 12-14 | 11.00 |
| WPM powder (90% | 14.00 | 0.00 | 0.00 |
| protein) | | | |
| WPM concentrate (20% | 0.00 | 0.00 | 45.00 |
| protein) | | | |
| Maltodextrins | 7.00 | 6-8 | 1.00 |
| Sucrose | 12.00 | 12.00 | 12.00 |
| Butter fat | 5.00 | 5-8 | 5.00 |
| Emulsifier/stabiliser | 0.30 | 0.3-0.5 | 0.30 |
| Flavouring | 0.20 | 0.20 | 0.20 |
| Water | 62.54 | 62.54 | 25.50 |
| Total | 100.00 | 100.00 | 100.00 |
| Kcal for 100 g: | 174 | 180 | 174 |
| Energy contribution from | 27 | 10 | 27 |
| proteins (%): | | | |
| Energy contribution from | 28 | 30 | 28 |
| fat (%): | | | |
| Energy contribution from | 45 | 60 | 45 |
| carbohydrates (%): | | | |

Using whey protein micelle powder according to the present invention either as the only source of protein or in combination with skimmed milk powder, it was possible to produce a high protein balanced ice cream. When using skimmed milk powder alone as the source of protein, only 5% protein content in the ice cream could be achieved.

Recipes 9-11

| | 9 | 10 | 11 |
|---|---|---|---|
| Whey protein isolate | 9.00 | 8-10 | 14.00 |
| SMP | 6.00 | 10-12 | 0.00 |
| Maltodextrins | 6.00 | 1.00 | 7.00 |
| Sucrose | 14.00 | 12.00 | 12.00 |
| Butter fat | 5.00 | 5.00 | 5.00 |
| Emulsifier/Stabiliser | 0.30 | 0.30 | 0.30 |
| Water | 59.70 | 61.70 | 61.70 |
| ANALYSIS | | | |
| Proteins | 10.20 | 11.95 | 12.60 |
| Di-saccharides | 17.00 | 17.50 | 12.00 |
| Poly-saccharide | 5.76 | 0.96 | 6.72 |
| Fat | 5.48 | 5.63 | 5.30 |
| Minerals | 1.02 | 1.42 | 0.84 |
| Water | 60.54 | 62.54 | 62.54 |
| Total | 100.00 | 100.00 | 100.00 |
| TS | 39.46 | 37.46 | 37.46 |
| Overrun | 100.00 | 100.00 | 100.00 |
| Calories (approximative calculations) | 184.10 | 176.10 | 174.10 |

High protein balanced ice cream using sources other than whey protein micelles were manufactured. When manufacturing such ice creams, no gelling issues were encountered during the pasteurisation step. The viscosity of the mix was high but processable during the freezing step.

1.-18. (canceled)

19. A pasteurized frozen dessert having a protein content per weight of more than 6%; an essentially neutral pH, and a fat caloric value of less than 45%.

20. The frozen dessert according to claim 19, wherein the protein content is more than 8 to 10% and the fat caloric value is less than 35%.

21. The frozen dessert according to claim 19, which has a pH value of between 6 and 8.

22. The frozen dessert according to claim 19, wherein that includes a fat.

23. The frozen dessert according to claim 19, in the form of an ice cream having per weight at least 8% proteins, 15-28% carbohydrates, and 3% to 7% fat.

24. The frozen dessert according to claim 23, having a protein content of more than 10%.

25. The frozen dessert according to claim 23, having a carbohydrate content of 20% to 26%.

26. The frozen dessert according to claim 23, having a fat content of 4% to 6%.

27. The frozen dessert according to claim 23, having per weight 8-12% protein, 15-20% carbohydrate, and 5 to 7% fat.

28. The frozen dessert according to claim 19, wherein the protein source is selected from whey protein isolates, whey protein concentrate, whey protein micelles, micellar casein, milk protein isolates, skimmed milk powder or a combination thereof.

29. The frozen dessert according to claim 19, wherein the protein source comprises whey protein micelles as spherical agglomerates of denatured whey protein, wherein the whey proteins are arranged in such a way that the hydrophilic parts of the proteins are oriented towards the outer part of the agglomerate and the hydrophobic parts of the protein are oriented towards the inner core of the micelle.

30. The frozen dessert according to claim 23, wherein the carbohydrate source is lactose, sucrose, glucose, or maltose.

31. The frozen dessert according to claim 23, wherein the fat source is milk fat.

32. The frozen dessert according to claim 19, having a calcium content of 0.1-1%.

33. The frozen dessert according to claim 19, having a phosphorus content of 0.1-0.5%.

34. The frozen dessert according to claim 19, which further comprises one or more of vitamins, minerals, probiotics, prebiotics, or inclusions.

35. The frozen dessert according to claim 19, wherein the protein content comprises casein and whey protein in a ratio of from between 0-100 to 80-20.

36. The frozen dessert according to claim 19, having an overrun of between 20% to 200%.
